(19) United States
(12) Patent Application Publication
(10) Pub. No.: US 2020/0393034 A1
(43) Pub. Date: Dec. 17, 2020

(54) ISOLATOR

(71) Applicant: GATES CORPORATION, Denver, CO (US)

(72) Inventors: Anthony R. Mora, Waterford, MI (US); Alexander Serkh, Troy, MI (US); Keming Liu, Sterling Heights, MI (US); Xiaohua Joe Chen, Lake Orion, MI (US)

(21) Appl. No.: 16/900,673

(22) Filed: Jun. 12, 2020

Related U.S. Application Data
(63) Continuation-in-part of application No. 16/441,985, filed on Jun. 14, 2019.

(51) Int. Cl. F16H 55/36

(52) U.S. Cl. CPC F16H 55/36; F16H 2055/366

(57) ABSTRACT

An isolator comprising a pulley and a shaft, the pulley journalled to the shaft, a load stop, a torsion spring, a damping member attached to the torsion spring, the damping member disposed between the load stop and the torsion spring, and the damping member compressing a damping fluid against the load stop; where the load stop is attached to the pulley or the shaft and the torsion spring is attached to the shaft or the pulley, respectively.

### FIELD OF THE INVENTION

The invention relates to an isolator, and more particularly, to an isolator having a damping member compressing a damping fluid against a pulley stop.

### BACKGROUND OF THE INVENTION

Diesel engine use for passenger car applications is increasing due to the benefit of better fuel economy. Further, gasoline engines are increasing compression ratios to improve the fuel efficiency. As a result, diesel and gasoline engine accessory drive systems have to overcome the vibrations of greater magnitude from crankshafts due to above mentioned changes in engines.

Due to increased crankshaft vibration plus high acceleration/deceleration rates and high alternator inertia the engine accessory drive system is often experiencing belt chirp noise due to belt slip. This will also reduce the belt operating life.

Crankshaft isolators/decouplers and alternator decouplers/isolators have been widely used for engines with high angular vibration to filter out vibration in engine operation speed range and to also control belt chirp.

The alternator isolator decoupler (AID) is a belt drive tuning device in the form of an alternator pulley. It is used to isolate vibrations and make accessory belt drive systems (ABDS) run more smoothly. The problem is that until now, the AID has always been a unidirectional device. Belt Driven Starter-Generator (BSG) systems are becoming more common and these systems have the functionality that the motor generator unit/belt starter-generator (MGU) can drive the belt in addition to the crank. Therefore they require a pulley with bidirectional functionality of which there has yet to be a tuning device to exhibit this characteristic. Therefore, a solid pulley on the alternator is typically coupled with an expensive crank torsional vibration damper tuning device. Not only is the crank damper expensive, most do not afford isolation or decoupling functionalities. Additionally, tensioners with high damping are also required to handle the demands of alternating tight and slack belt sides in BSG systems.

Representative of the art is U.S. Pat. No. 8,888,622 which discloses an isolator decoupler comprising a shaft, a pulley journalled to the shaft, a clutch carrier journalled to the shaft through a one-way clutch, a torsion spring engaged between the pulley and the clutch carrier, the torsion spring loadable in an unwinding direction, the torsion spring and the pulley having a predetermined clearance between a torsion spring outside diameter surface and a pulley inside diameter surface, and whereby the torsion spring outside diameter surface and a pulley inside diameter surface come into a progressive frictional engagement by torque load dependent radial expansion of the torsion spring.

What is needed is an isolator having a damping member compressing a damping fluid against a load stop. The present invention meets this need.

### SUMMARY OF THE INVENTION

The primary aspect of the invention is an isolator having a damping member compressing a damping fluid against a load stop.

Other aspects of the invention will be pointed out or made obvious by the following description of the invention and the accompanying drawings.

The invention comprises an isolator comprising a pulley, a shaft, the pulley journalled to the shaft, a load stop, a torsion spring, a damping member attached to the torsion spring, the damping member disposed between the load stop and the torsion spring, and the damping member compressing a damping fluid against the load stop. The load stop maybe attached to the pulley and the torsion spring attached to the shaft. Alternately, the load stop maybe attached to the shaft and the torsion spring attached to the pulley. The damping member may be disposed between two load stops.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIGS. 1-13 depict a first embodiment.

FIG. 1 is an exploded view of the first embodiment.

FIG. 2 is a cross section view.

FIG. 3 is a cross section view.

FIG. 4 is a perspective view.

FIG. 5 is a perspective view of the bottom of FIG. 4.

FIG. 6 is a perspective view.

FIG. 7 is a plan view.

FIG. 8 is a perspective view of the ring.

FIG. 9 is a cross section view of the installed device.

FIG. 10 is a perspective view of the ring.

FIG. 11A shows high pressure regions for the damping fluid in a first operational direction.

FIG. 11B shows high pressure regions for the damping fluid in a second operational direction.

FIG. 12 is a cut away of the receiver portion.

FIG. 13 is a cross section of the device.

FIGS. 14-26 depict a second embodiment.

FIG. 14 is an exploded view of the second embodiment.

FIG. 15 is a cross section view.

FIG. 16 is a cross section view.

FIG. 17 is a perspective view.

FIG. 18 is a perspective view of the bottom of FIG. 17.

FIG. 19 is a perspective view.

FIG. 20 is a plan view.

FIG. 21 is a perspective view of the ring.

FIG. 22 is a cross section view of the installed device.

FIG. 23 is a perspective view of the ring.

FIG. 24A shows high pressure regions for the damping fluid in a first operational direction.

FIG. 24B shows high pressure regions for the damping fluid in a second operational direction.

FIG. 25 is a cut away of the receiver portion.

FIG. 26 is a cross section of the device.

### DETAILED DESCRIPTION OF THE PREFERRED EMBODIMENT

The instant invention affords isolation and decoupling capabilities in both directions as it utilizes a torsion spring that is connected to a series of bidirectional parts through a series of welds. The device can be loaded in either operational direction coupled with a decoupling and torque transmitting ring. This decoupling occurs when the MGU shaft or the rotor moves faster than the pulley, a phenomenon referred to as overrunning. It also affords damping characteristics through viscous drag. Not only does the viscous drag damp the system, it also has the advantage that it functions to eliminate impact noise from spring engagement. This solves the problem of having to introduce an expensive crank tuning device with damper, tensioner with high damping, and introduces isolation into ABDS systems.

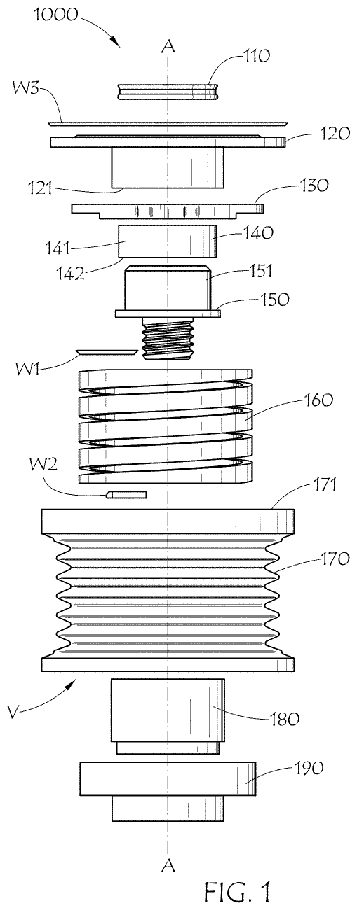

FIG. 1 is an exploded view of the first embodiment. The device 1000 comprises dust cap 110, outer plate 120, ring 130, bushing 140, screw 150, spring 160, pulley 170, shaft 180, and bearing 190.

Ring 130 is welded to an end of spring 160 with weld W1. Weld W1 extends through approximately 90°. Shaft 180 is welded to the other end of spring 160 with weld W2. Weld W2 extends through approximately 90°. Outer plate 120 is welded to pulley 170 with weld W3. Weld W3 extends through approximately 360°. Weld W1, W2 and W3 can each be accomplished by laser or other suitable weld method.

An outer surface 141 engages an inner surface 121. An inner surface 142 engages an outer surface 151. Bushing 140 is disposed between outer plate 120 and screw 150. Bushing 140 is a low friction bushing.

Dust cap 110 snaps into opening 122 in outer plate 120.

Bearing 190 is disposed between shaft 180 and pulley 170. Pulley 170 is journalled to an alternator (not shown) on bearing 190 and bushing 140. Torque is transmitted through shaft 180.

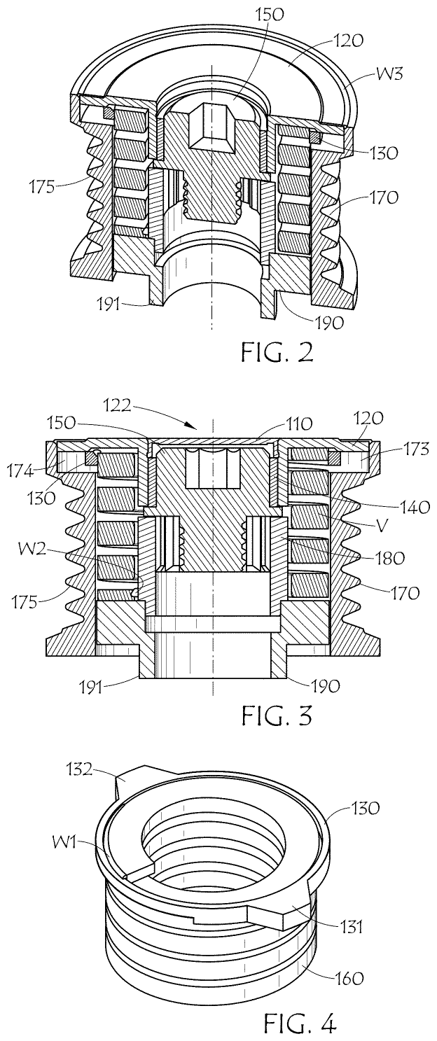

FIG. 2 is a cross section view. Ring 130 is disposed between outer plate 120 and receiver 173 and receiver 174. Screw 150 fixes the device to a driven component, such as an MGU (not shown) see FIG. 9. Outer surface 175 of pulley 170 engages a belt (not shown). Bearing 190 comprises a flange 191 to engage an MGU shaft (not shown).

FIG. 3 is a cross section view. Dust cap 110 prevents debris from entering the device.

FIG. 4 is a perspective view. Ring 130 comprises two radial extensions 131 and 132. Extensions 131 and 132 are spaced 180° apart. Weld W1 fixes ring 130 to an end of spring 160. Ring 130 is welded at the outer diameter of spring 160. The extensions are disposed between the load stops.

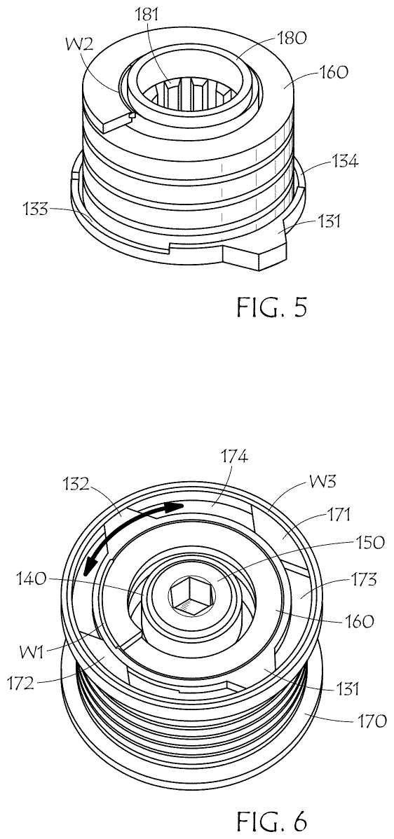

FIG. 5 is a perspective view of the bottom of FIG. 4. Shaft 180 is welded to the other end of spring 160 with weld W2. Shaft 180 is welded at the inner diameter of spring 160. Shaft 180 comprises splines 181 which mechanically engage an MGU shaft (not shown). Ring 130 comprises a relief 133 and relief 134.

FIG. 6 is a perspective view. Extension 132 engages receiver 174 and moves between pulley load stop 171 and pulley load stop 172. Extension 131 engages receiver 173 and moves between stop 171 and stop 172. Extension 132 engages stop 171 as extension 131 engages stop 172. Extension 132 engages stop 172 as extension 131 engages stop 171.

Receiver 173 and receiver 174 receive a viscous damping fluid. The damping fluid can also extend to and communicate with the pulley internal volume wherein spring 160 is disposed.

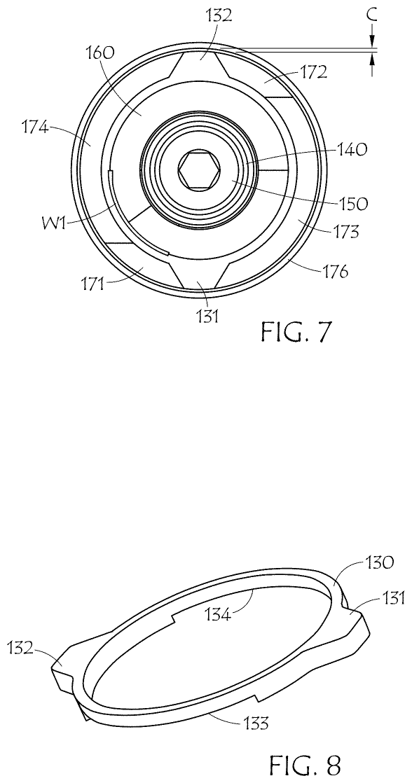

FIG. 7 is a plan view. A clearance C is provided between a pulley rim 176 and an outer portion of extension 132 and extension 131. Clearance C provides a path for the damping fluid to flow by extension 131 and extension 132 during operation. The width of C is tunable in accordance with design and damping requirements.

FIG. 8 is a perspective view of the ring. A relief 133 is disposed between extension 131 and extension 132. A relief 134 is disposed between extension 131 and extension 132 opposite relief 133. The angular extent a of relief 133 and relief 134 are each approximately 90°. Angle α is tunable depending on design requirements.

FIG. 9 is a cross section view of the installed device. The device 1000 is mounted to a shaft S of a motor generator unit (MGU).

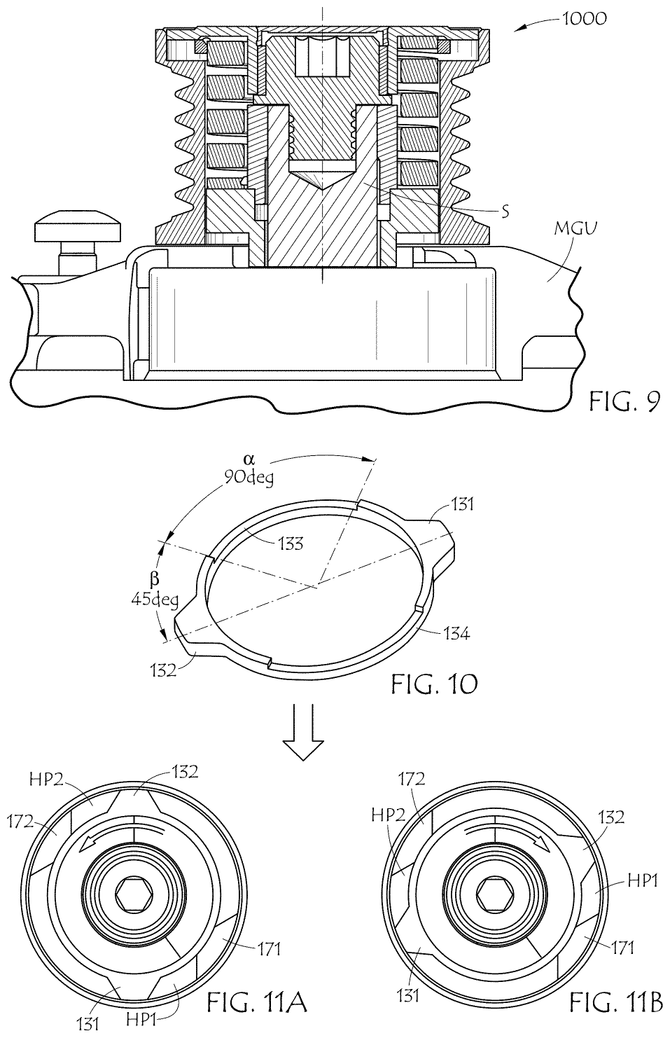

FIG. 10 is a perspective view of the ring. An angle R between a centerline of extension 132 and relief 133 is approximately 45°. A like angle exists to relief 134. An angle β between a centerline of extension 131 and relief 133 is approximately 45°. A like angle exists to relief 134 as well from a centerline of extension 131.

Each relief 133 and 134 provide a passage for the damping fluid for that portion of the rotational movement of ring 130 when each extension 131 and 132 are moving between pulley load stops 171 and 172.

The dimensional characteristics of ring 130 can be changed thereby making the damping behavior of the device tunable. If the dimensional relationship between each relief 133, 134, and each stop 171 and 172 is symmetric, then the damping effect will be the same in either operational direction. The damping effect can be made different between a first operational direction and a second operational direction by changing the angle α for relief 133 from angle α for relief 134. The angle β can also be changed to alter the damping effect between operational directions as well. Of course, a change in angle α will in turn have a change on angle β.

FIG. 11A shows high pressure regions for the damping fluid in a first operational direction. In operation as extension 132 approaches stop 172 a high pressure region HP2 is formed in the damping fluid. Movement of ring 130 with respect to pulley 170 is indicated by the arrow. Region HP2 cushions engagement of extension 132 to stop 172, reducing noise. As extension 131 approaches stop 171 a high pressure region HP1 is formed in the damping fluid. Region HP1 cushions engagement of extension 131 to stop 171, reducing noise.

FIG. 11B shows high pressure regions for the damping fluid in a second operational direction. In operation as extension 132 approaches stop 171 a high pressure region HP1 is formed in the damping fluid. Movement of ring 130 with respect to pulley 170 is indicated by the arrow. Region HP1 cushions engagement of extension 132 to stop 171, reducing noise. As extension 131 approaches stop 172 a high pressure region HP2 is formed in the damping fluid. Region HP2 cushions engagement of extension 131 to stop 172, reducing noise.

The damping fluid may comprise grease or oil. The viscosity can be in the range of approximately 68 cSt at 40 deg C. to approximately 3000 cSt at 40 deg C. For example, the oil may comprise Mobile® SHC 626. The grease may comprise Royal Purple® PS0711-0408. These damping fluids are examples only and are not intended to limit the scope of the invention.

The damping fluid fill for receiver 173 and receiver 174 may be in the range of approximately 50% to approximately 90%. A preferred amount is approximately 75% by volume.

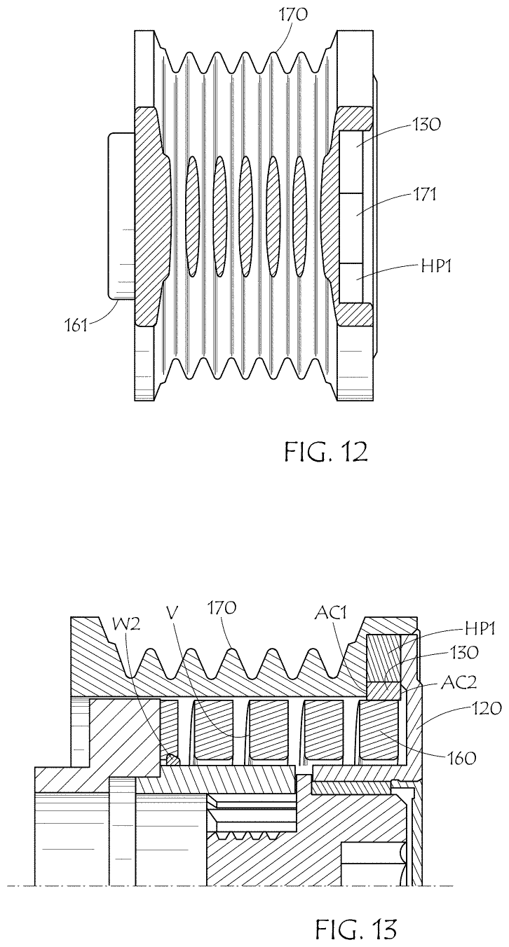

FIG. 12 is a cut away of the receiver portion. Region HP1 is shown adjacent stop 171.

FIG. 13 is a cross section of the device. The damping fluid can communicate with the pulley internal volume V through clearance AC1 and clearance AC2. Clearance AC1 is between ring 130 and pulley 170. Clearance AC2 is between ring 130 and outer plate 120. The damping fluid can move through clearances AC1 and AC2 from high pressure region HP1. The pulley internal volume acts as a reservoir for the damping fluid.

Movement of the damping fluid through clearances AC1 and AC2 allows for bleed down of the high pressure region HP1 and HP2 which then allows for a soft landing of the extensions on the stops which in turn reduces noise generation.

The dimension of AC1 and AC2 are tunable in order to achieve a desired bleed rate for the damping fluid in the 25 high pressure region. Clearance AC1 and AC2 may comprise approximately 0.1 mm.

Operation

The device is typically attached to an MGU. The MGU is an accessory of a vehicle engine. If the engine is at rest and about to be started via the engine crankshaft, pulley 170 will rotate uncoupled to the MGU shaft until stops 171, 172 engage extensions 131, 132 of ring 130. This in turn transmits load into spring 160 weld W1. Spring 160 then transmits load into shaft 180 via weld W2, which then transmits load to shaft 180 causing it to rotate.

Spring 160 transmits load and it also isolates angular and torsional vibrations introduced to the system due to piston firings while the engine is running.

If the engine is started via the MGU, the MGU shaft rotates and transmits torque to shaft 180, which then transmits torque to spring 160 through weld W2. Spring 160 then transmits torque to ring 130 via weld W1. Ring 130 then rotates through receiver 173, 174 until it hits the stops 171, 172 on pulley 170. Torque is transmitted through ring 130 into the pulley 170 which drives the belt, turns the crankshaft, and starts the engine.

The ring 130 and receiver 173, 174 system not only works as a bidirectional clutch, it also functions as a decoupler. As mentioned before, between piston firings, the belt slows down. This in turn slows down the accessory pulleys. For pulleys rigidly connected to accessory shafts, the shafts slow down as well. In the instant device, if the pulley slows down relative to the shaft, stops 171, 172 will disengage from extensions 131, 132, allowing decoupling through whichever angle the receivers 173, 174 extend 120° in the given embodiment. This decoupling serves to reduce speed fluctuations in the MGU shaft, allowing the MGU to more effectively charge the battery when in generation mode as well as reducing the harmful effects of torsional vibrations on the MGU.

When stops 171, 172 are contacted by extensions 131, 132, and torque is being transmitted in one way or another (pulley to shaft, or shaft to pulley) and the torque on one component is greater than the other (shaft torque greater than pulley torque or vice versa), torsion spring 160 is loaded to absorb/isolate the additional torque rather than transmit a torque/speed variation into the accessory system.

The use of welds to connect the ends of spring 160 the load bearing/transmitting components permits loading of the spring in either direction, winding or unwinding. This bidirectional loading capacity allows isolation effects to be produced in either direction.

A third functionality of the system is damping. This occurs during decoupling events in which extensions 131, 132 slide through the damping fluid in receivers 173, 174. Damping occurs as a result of viscous drag produced as the extensions displaces the grease in the receivers. The ring with its extensions thus functions as a damping member in cooperation with the damping fluid and the load stops. Typically, starter generator systems require tensioners with high damping characteristics; however the utilization of a tuning device that affords damping can reduce the damping requirements of the tensioner. Furthermore, the damping exhibited by the device can be tuned by altering the type of grease used.

Clearance C between the end of extensions 131, 132 and wall of receivers 173, 174 is kept small to increase damping. This small clearance causes the grease to tend to pack up between the extensions 131 and 132 and stops 171, 172. The more tightly the grease is packed, the greater the resistance, thereby producing greater damping. To prevent total pack up which would prevent motion, reliefs 133, 134 are included in ring 130. The reliefs 133, 134 allow some grease to be displaced out of the path of the extensions 131, 132 as it moves through the receivers 173, 174. Not only do the reliefs 133, 134 work to permit motion, they also allow the grease to be continuously cycled and mixed to prevent oil separation and other detrimental effects of stagnant grease. Outer plate 120 also functions as a cover member, attached to pulley 170, enclosing receivers 173, 174 and keeping the damping fluid therein.

Ring 130 and pulley 170 are symmetric parts to allow them to function in either direction. However, ring 130 and pulley 170 can be designed asymmetrically as previously described.

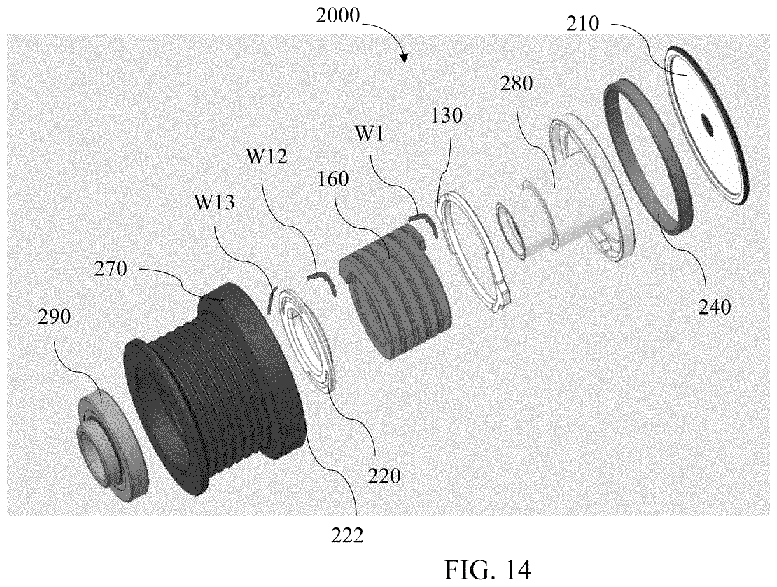

FIG. 14 is an exploded view of the second embodiment. The device 2000 comprises dust cap 210, ring 130, bushing 240, spring 160, pulley 270, shaft 280, and bearing 290.

Ring 130 is welded to an end of spring 160 with weld W1. Weld W1 extends through approximately 90°. Pulley 270 is welded to the other end of spring 160 through spring retainer 220 with welds W12 and W13. Welds W12 and W13 extend through approximately 90°. Weld W1, W12 and W13 can each be accomplished by laser or other suitable weld method.

Bushing 240 is disposed between pulley 270 and shaft 280. Bushing 240 is a low friction bushing.

Dust cap 210 snaps into opening 222 in inner surface of pulley 270.

Bearing 290 is disposed between shaft 280 and pulley 270. Pulley 270 is journalled to an alternator (not shown) on bearing 290 and bushing 240. Torque is transmitted through shaft 280.

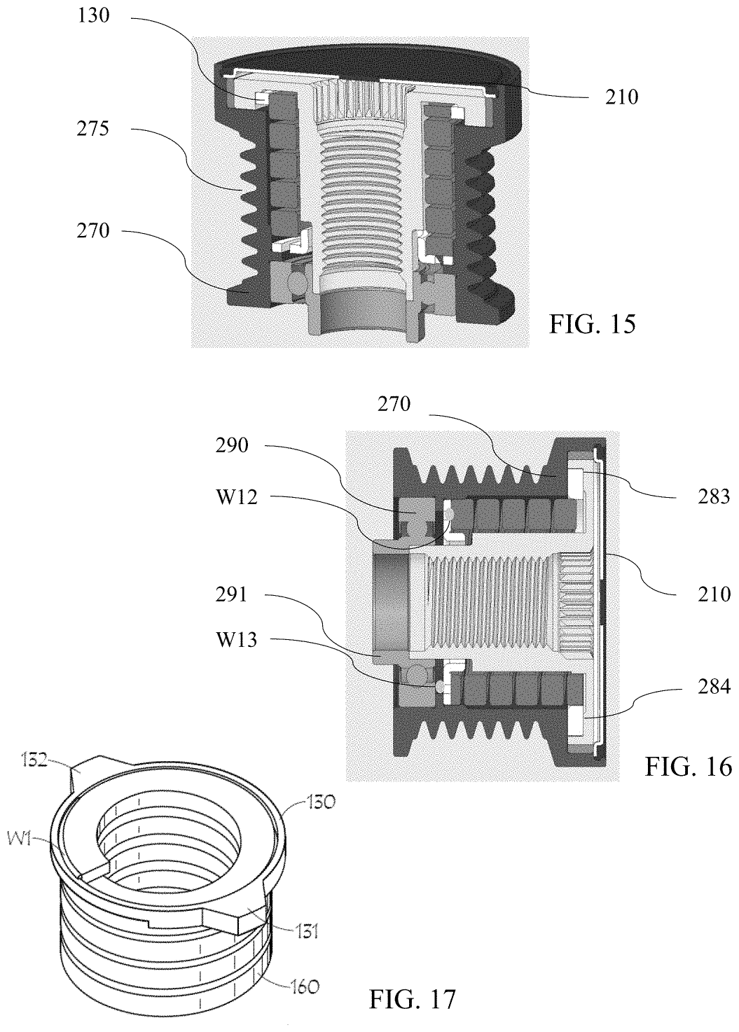

FIGS. 15 and 16 are cross section views. Ring 130 is disposed between pulley 270 and receiver 283 and receiver 284 on shaft 280. Outer surface 275 of pulley 270 engages a belt (not shown). Bearing 290 comprises a flange 291 to engage an MGU shaft (not shown). Dust cap 210 prevents debris from entering the device.

FIG. 17 is a perspective view. Ring 130 comprises two radial extensions 131 and 132. Extensions 131 and 132 are spaced 180° apart. Weld W1 fixes ring 130 to an end of spring 160. Ring 130 is welded at the outer diameter of spring 160. The extensions are disposed between the load stops.

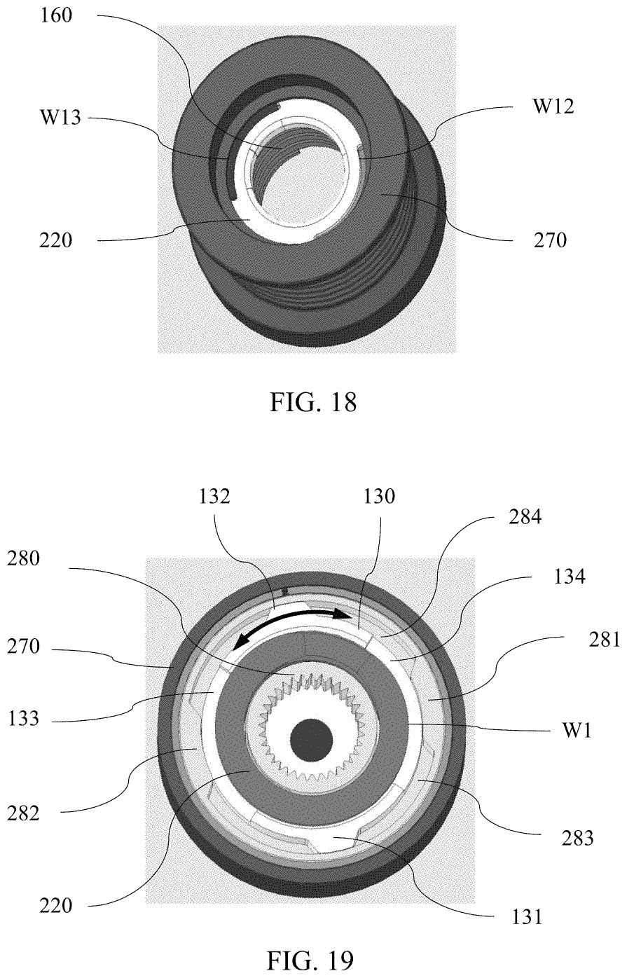

FIG. 18 is a perspective view of the bottom of FIG. 17. Pulley 270 is welded to the other end of spring 160 with welds W12 and W13 through spring retainer 220. Pulley 270 can be welded to the other end of the spring 160 directly with a single weld (not shown).

FIG. 19 is a perspective view. Ring 130 comprises a relief 133 and relief 134. Extension 132 engages receiver 284 and moves between shaft load stop 281 and shaft load stop 282. Extension 131 engages receiver 283 and moves between load stop 281 and load stop 282. Extension 132 engages stop 281 as extension 131 engages stop 282. Extension 132 engages stop 282 as extension 131 engages stop 281.

Receiver 283 and receiver 284 receive a viscous damping fluid. The damping fluid can also extend to and communicate with the pulley internal volume wherein spring 160 is disposed.

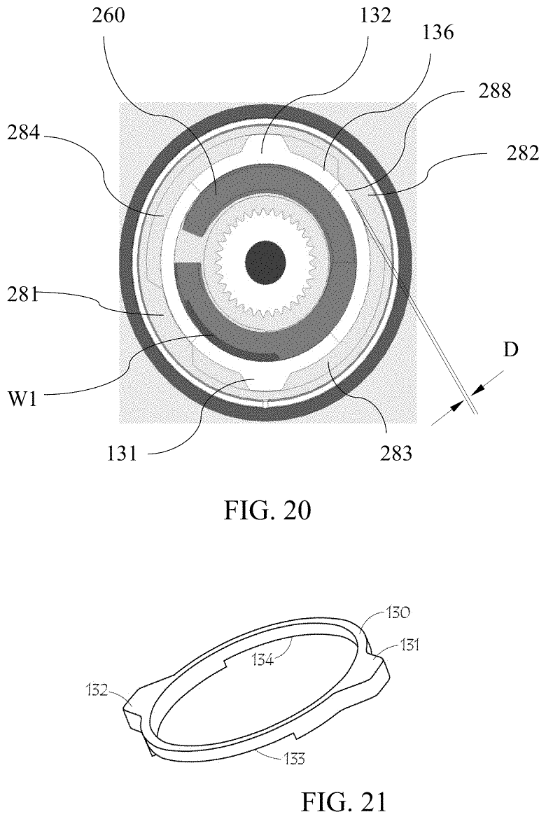

FIG. 20 is a plan view. A clearance D is provided between a ring 130 outer surface 136 and stop 281, 282 inner surface 288. Clearance D provides a path for the damping fluid to flow by stop 281 and stop 282 during operation. The width of D is tunable in accordance with design and damping requirements.

FIG. 21 is a perspective view of the ring. A relief 133 is disposed between extension 131 and extension 132. A relief 134 is disposed between extension 131 and extension 132 opposite relief 133.

FIG. 22 is a cross section view of the installed device. The device 1000 is mounted to a shaft S of a motor generator unit (MGU).

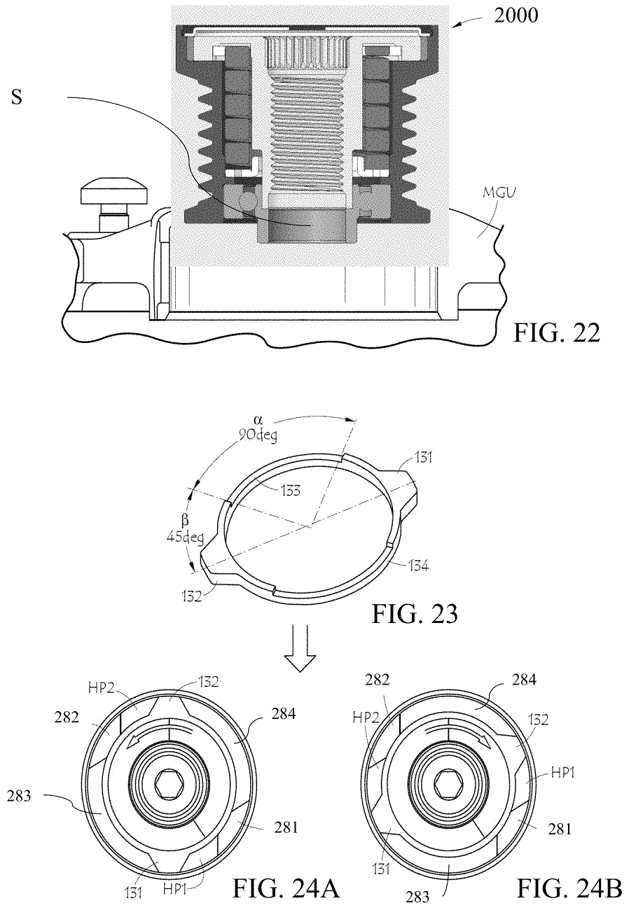

FIG. 23 is a perspective view of the ring. The angular extent a of relief 133 and relief 134 are each approximately 90°. Angle α is tunable depending on design requirements. An angle β between a centerline of extension 132 and relief 133 is approximately 45°. A like angle exists to relief 134. An angle β between a centerline of extension 131 and relief 133 is approximately 45°. A like angle exists to relief 134 as well from a centerline of extension 131.

Each relief 133 and 134 provide a passage for the damping fluid for that portion of the rotational movement of ring 130 when each extension 131 and 132 are moving between stops 281 and 282.

The dimensional characteristics of ring 130 can be changed thereby making the damping behavior of the device tunable. If the dimensional relationship between each relief 133, 134 and each stop 281 and 282 is symmetric, then the damping effect will be the same in either operational direction. The damping effect can be made different between a first operational direction and a second operational direction by changing the angle α for relief 133 from angle α for relief 134. The angle β can also be changed to alter the damping effect between operational directions as well. Of course, a change in angle α will in turn have a change on angle β.

FIG. 24A shows high pressure regions for the damping fluid in a first operational direction. In operation as extension 132 approaches stop 282 a high pressure region HP2 is formed in the damping fluid. Movement of ring 130 with respect to pulley 270 is indicated by the arrow. Region HP2 cushions engagement of extension 132 to stop 282, reducing noise. As extension 131 approaches stop 281 a high pressure region HP1 is formed in the damping fluid. Region HP1 cushions engagement of extension 131 to stop 281, reducing noise.

FIG. 24B shows high pressure regions for the damping fluid in a second operational direction. In operation as extension 132 approaches stop 281 a high pressure region HP1 is formed in the damping fluid. Movement of ring 130 with respect to pulley 270 is indicated by the arrow. Region HP1 cushions engagement of extension 132 to stop 281, reducing noise. As extension 131 approaches stop 282 a high pressure region HP2 is formed in the damping fluid. Region HP2 cushions engagement of extension 131 to stop 282, reducing noise.

The damping fluid may comprise grease or oil. The viscosity can be in the range of approximately 68 cSt at 40 deg C. to approximately 3000 cSt at 40 deg C. For example, the oil may comprise Mobile® SHC 626. The grease may comprise Royal Purple® PS0711-0408. These damping fluids are examples only and are not intended to limit the scope of the invention.

The damping fluid fill for receiver 283 and receiver 284 may be in the range of approximately 50% to approximately 90%. A preferred amount is approximately 75% by volume.

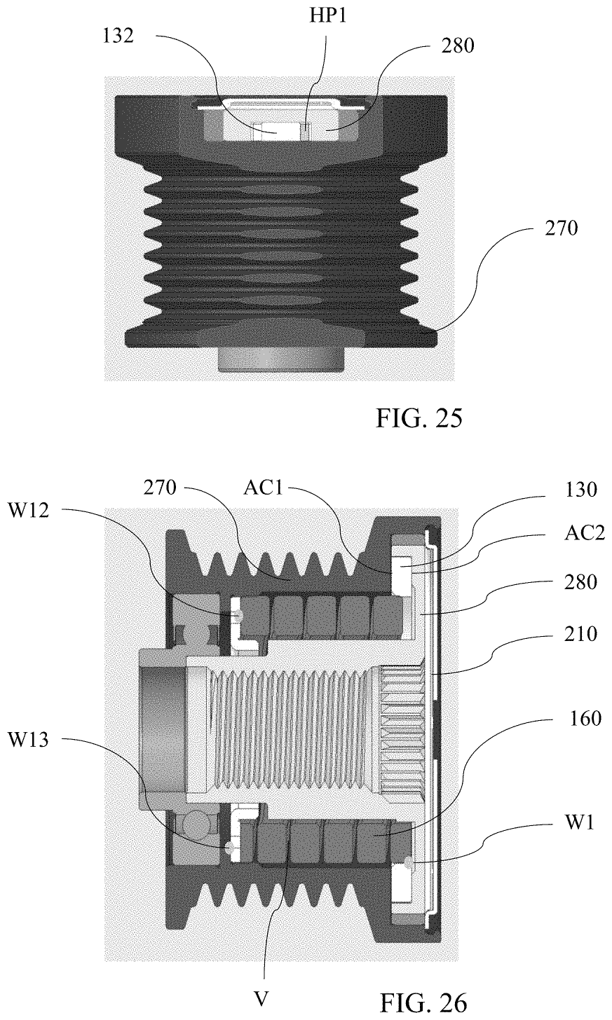

FIG. 25 is a cut away of the receiver portion. Region HP1 is shown adjacent stop 281.

FIG. 26 is a cross section of the device. The damping fluid can communicate with the pulley internal volume V through clearance AC1 and clearance AC2. Clearance AC1 is between ring 130 and pulley 270. Clearance AC2 is between ring 130 and shaft 280. The damping fluid can move through clearances AC1 and AC2 from high pressure region HP1. The pulley internal volume acts as a reservoir for the damping fluid.

Movement of the damping fluid through clearances AC1 and AC2 allows for bleed down of the high pressure region HP1 and HP2 which then allows for a soft landing of the extensions on the stops which in turn reduces noise generation.

The dimension of AC1 and AC2 are tunable in order to achieve a desired bleed rate for the damping fluid in the high pressure region. Clearance AC1 and AC2 may comprise approximately 0.1 mm.

Operation

The device is typically attached to an MGU. The MGU is an accessory of a vehicle engine. If the engine is at rest and about to be started via the engine crankshaft, pulley 270 will rotate with spring 160 and ring 130 transmitting torque through weld W13, spring retainer 220, weld W12, spring 160, weld W1, to ring 130. Spring 160 will rotate uncoupled to the MGU shaft until extensions 131, 132 of ring 130 engage shaft load stops 281, 282 which then transmits load to shaft 280 causing it to rotate.

Spring 160 transmits load and it also isolates angular and torsional vibrations introduced to the system due to piston firings while the engine is running.

If the engine is started via the MGU, the MGU shaft rotates and transmits torque to shaft 280. Shaft 280 rotates with receivers 283, 284 until stops 281, 282 engage extensions 131, 132 of ring 130. Ring 130 then transmits torque to spring 160 via weld W1. Spring 160 transmits torque to pulley 270 via weld W12, spring retainer 220, and weld W13. Pulley 270 drives the belt, turns the crankshaft, and starts the engine.

The ring 130 and receiver 283, 284 system not only works as a bidirectional clutch, it also functions as a decoupler. As mentioned before, between piston firings, the belt slows down. This in turn slows down the accessory pulleys. For pulleys rigidly connected to accessory shafts, the shafts slow down as well. In the instant device (solid alternator pulley), if the pulley slows down relative to the shaft, stops 281, 282 will disengage from extensions 131, 132, allowing decoupling through whichever angle the receivers 283, 284 extend, 120° in the given embodiment. This decoupling serves to reduce speed fluctuations in the MGU shaft, allowing the MGU to more effectively charge the battery when in generation mode as well as reducing the harmful effects of torsional vibrations on the MGU.

When stops 281, 282 are contacted by extensions 131, 132, and torque is being transmitted in one way or another (pulley to shaft, or shaft to pulley) and the torque on one component is greater than the other (shaft torque greater than pulley torque or vice versa), torsion spring 160 is loaded to absorb/isolate the additional torque rather than transmit a torque/speed variation into the accessory system.

The use of welds to connect the ends of spring 160 the load bearing/transmitting components permits loading of the spring in either direction, winding or unwinding. This bidirectional loading capacity allows isolation effects to be produced in either direction.

A third functionality of the system is damping. This occurs during decoupling events in which extensions 131, 132 slide through the damping fluid in receivers 283, 284. Damping occurs as a result of viscous drag produced as the extensions displaces the grease in the receivers. The ring with its extensions thus functions as a damping member in cooperation with the damping fluid and the load stops. Typically, starter generator systems require tensioners with high damping characteristics; however the utilization of a tuning device that affords damping can reduce the damping requirements of the tensioner. Furthermore, the damping exhibited by the device can be tuned by altering the type of grease used.

Clearance D between stops 281, 282 inner surface 288 and ring 130 outer surface 136 is kept small to increase damping. This small clearance causes the grease to tend to pack up between the extensions 131 and 132 and stops 281, 282. The more tightly the grease is packed, the greater the resistance, thereby producing greater damping. To prevent total pack up which would prevent motion, reliefs 133, 134 are included in ring 130. The reliefs 133, 134 allow some grease to be displaced out of the path of the extensions 131, 132 as it moves through the receivers 283, 284. Not only do the reliefs 133, 134 work to permit motion, they also allow the grease to be continuously cycled and mixed to prevent oil separation and other detrimental effects of stagnant grease.

Ring 130 and shaft 280 are symmetric parts to allow them to function in either direction. However, ring 130 and shaft 280 can be designed asymmetrically as previously described.

Although forms of the invention have been described herein, it will be obvious to those skilled in the art that variations may be made in the construction and relation of parts without departing from the scope of the invention described herein. Unless otherwise specifically noted, components depicted in the drawings are not drawn to scale. Further, it is not intended that any of the appended claims or claim elements invoke 35 U.S.C. § 112(f) unless the words “means for” or “step for” are explicitly used in the particular claim. The present disclosure should in no way be limited to the exemplary embodiments or numerical dimensions illustrated in the drawings and described herein.

We claim:

1. An isolator comprising:
a shaft;
a pulley journalled to the shaft;
a load stop;
a torsion spring; and
a damping member attached to the torsion spring; and
the damping member compressing a damping fluid against the load stop.

2. The isolator as in claim 1, wherein the damping member is disposed between the load stop and the torsion spring.

3. The isolator as in claim 1, wherein the damping member comprises a radial extension which cooperates with the load stop.

4. The isolator as in claim 3, further comprising a second load stop, wherein the extension is disposed between the load stops.

5. The isolator as in claim 1, wherein the damping member is attached to the torsion spring by a weld.

6. The isolator as in claim 1, wherein the damping fluid comprises grease.

7. The isolator as in claim 1, wherein the damping fluid comprises oil.

8. The isolator as in claim 1, wherein the damping member comprises a relief to allow a damping fluid flow.

9. The isolator as in claim 1, wherein the viscosity of the damping fluid is in the range of 68 cSt at 40 deg C. to 3000 cSt at 40 deg C.

10. An isolator as in claim 1 further comprising a plate;
wherein the load stop is a pulley load stop;
the damping member is disposed between the plate and the pulley; and
the damping member compresses the damping fluid against the pulley load stop.

11. The isolator as in claim 10, wherein the plate is attached to the pulley by a weld.

12. The isolator as in claim 10, wherein the torsion spring is attached to the shaft by a weld.

13. The isolator as in claim 10, wherein the damping member comprises a radial extension which cooperates with the pulley load stop.

14. The isolator as in claim 10, wherein the pulley is further journalled to the shaft with a bushing, the bushing engaged with the plate.

15. The isolator as in claim 10 further comprising an attaching screw cooperating with the shaft.

16. The isolator as in claim 10, wherein the pulley comprises a volume to receive the damping fluid.

17. The isolator as in claim 10 further comprising a dust cap engaged with the plate.

18. The isolator as in claim 10, wherein the pulley comprises a receiver receiving the damping fluid and the damping member.

19. An isolator comprising:
a pulley having a pulley load stop;
a shaft;
the pulley journalled to the shaft;
a torsion spring attached to the shaft;
a damping member attached to the torsion spring, the damping member comprising at least one radial extension that cooperates with the pulley load stop;
the pulley having a receiver receiving a damping fluid and the damping member;
a cover member attached to the pulley enclosing the receiver; and
the damping member compressing the damping fluid against the pulley load stop, the viscosity of the damping fluid in the range of 68 cSt at 40 deg C. to 3000 cSt at 40 deg C.

20. An isolator as in claim 1, wherein the load stop is a shaft load stop, and the damping member compresses the damping fluid against the shaft load stop.

21. The isolator as in claim 20, wherein the torsion spring is attached to the pulley by a weld.

22. The isolator as in claim 20, wherein the damping member comprises a radial extension which cooperates with the shaft load stop.

23. The isolator as in claim 20, wherein the pulley is further journalled to the shaft with a bushing.

24. The isolator as in claim 20, wherein the shaft comprises a volume to receive the damping fluid.

25. The isolator as in claim 20 further comprising a dust cap engaged with the pulley.

26. The isolator as in claim 20, wherein the shaft comprises a receiver receiving the damping fluid and the damping member.

27. An isolator comprising:
a pulley;
a shaft having a shaft load stop;
the pulley journalled to the shaft;
a torsion spring attached to the pulley;
a damping member attached to the torsion spring, the damping member comprising at least one radial extension that cooperates with the shaft load stop;
the shaft having a receiver receiving a damping fluid and the damping member;
the damping member compressing the damping fluid against the shaft load stop, the viscosity of the damping fluid in the range of 68 cSt at 40 deg C. to 3000 cSt at 40 deg C.
